(19) United States
(12) Patent Application Publication
(10) Pub. No.: US 2008/0243530 A1
(43) Pub. Date: Oct. 2, 2008

(54) Method for auditing product damage claims utilizing shock sensor technology

(76) Inventor: James Stubler, Henderson, NV (US)

Correspondence Address: STETINA BRUNDA GARRED & BRUCKER, 75 ENTERPRISE, SUITE 250, ALISO VIEJO, CA, 92656, US

(21) Appl. No.: 11/728,818

(22) Filed: Mar. 27, 2007

(51) Int. Cl. G06Q 50/00

(52) U.S. Cl. 705/1

(57) ABSTRACT

There is provided a method for auditing product damage claims by a warranty service department on consumer products subject to manufacturer warranty guidelines. The method comprises the steps of receiving a product damage claim on a consumer product from a consumer, detecting/downloading product impact sensor data from a product impact sensor on the consumer product, and determining the coverage available for a product damage claim under manufacturer warranty guidelines based upon a comparison of the product impact sensor data to a warranty level impact.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to a method for auditing product damage claims submitted to a manufacturer warranty service department under a manufacturer's warranty guidelines which incorporates impact sensor technology to detect the timing and magnitude of impact sustained by consumer products.

Manufacturer warranty service departments are presented with countless warranty claims each year on damaged consumer electronic devices such as cell phones, portable CD or DVD players, personal digital assistants as well as home electronic devices such as stereos, televisions, and fax machines. In many instances, although these devices show no obvious evidence of damage such as exterior scraping or cracking, these products may nonetheless have sustained disabling damage after having been dropped by the consumer onto the ground or compressed under the weight of heavy objects. Often, upon receiving a claim from a consumer, a warranty service department will elect to incur the cost of repairing or replacing the disabled device in the absence of any obvious mishandling or abuse by the consumer of the product in question. Without such evidence, despite the existence of a warranty provision excluding liability for damage to the product caused by improper use, mishandling, or abuse by the consumer, the manufacturer will incur the costs of repair and/or replacement without further inquiry or investigation. Even if improper handling or misuse is suspected by the manufacturer, its warranty service departments often spend little time and effort investigating the cause of a product's disabling event due to the absence of appropriate technological and personal resources. Likewise, a consumer may be denied a warranty claim for a malfunctioning consumer product by a manufacturer's warranty department, even though an adequate investigation of the basis for the malfunction has not been performed, and actual product abuse has not been proven.

The widespread use of consumer electronic devices and home electronics and the accompanying number of product damage claims may make it cost prohibitive to adequately investigate the cause of these product's disablement. As a result, many product warranty claims for these devices are authorized by a manufacturer's warranty service department, even though the actual cause of the damage, if known to the manufacturer, would be excluded under the manufacturer's warranty guidelines. Understandably, many manufacturers and their warranty service departments would presumably be interested in an opportunity to determine the timing, magnitude, and therefore cause of product disabling events in an efficient, cost-effective and verifiable manner. In accordance with the present invention, warranty service guidelines are referred to an impact sensor, selected to properly evidence product mishandling, misuse, and/or abuse due to droppage or compression are likely the responsible causes. If so, the consumer's product warranty claim may be appropriately denied and the warranty period voided for the damaged product in question. If not, the consumer's claim should be properly approved.

Currently, manufacturer warranty service departments are limited in their investigation to obvious evidence of mishandling, misuse, and/or abuse to a product submitted under a product damage claim. In the absence of such evidence, the level of investigation needed to determine the actual cause of the damage to the product is cost-prohibitive, with the cost of repair and/or replacement being the preferred alternative in resolving these product damage claims. Likewise, consumers may also be frustrated by an inability to disprove an allegation of abuse.

Consequently, consumers, manufacturers and warranty service providers could all benefit from an innovative alternative to the current product warranty assessment process.

Accordingly, there is a need in the art for an improved method of auditing product damage claims by a warranty service department under the manufacturer's warranty guidelines which utilize impact sensors measuring the timing and magnitude of shock, vibration, and blunt force to which a consumer product may have been exposed in order to determine whether the product has been dropped or mishandled, thereby excluding the product from warranty protection. Such a method could facilitate allowance of proper claims and substantially reduce the number and the associated disposition time for denied product damage claims. Replacement and/or repair under a manufacturer's warranty guidelines is tied to a sensor, such as a visual sensor which is used as evidence that the damage to the product is due to customer mishandling, misuse, and/or abuse. A method is needed to allow resolution of warranty claims based on an inspection of the sensor when presented to the warranty service department, without delay, and in a cost-effective manner, thereby drastically reducing the complexity of many product damage claims. A readily perceivable basis for discouraging improper claims is expected to reduce manufacturer's damage claim losses. In particular, the cost of processing a product warranty claim subsequently shown to not be covered under the manufacturer's warranty guidelines due to consumer mishandling, misuse, and/or abuse may be avoided, and not passed on to the consumer. This may expedite allowance of proper damage claims, and also serve as a valuable deterrent in preventing the submission of product damage claims to a warranty service department known by the consumer to be caused by product mishandling, misuse, and/or abuse. Likewise, a manufacturer's warranty service department will be disinclined to reject a product damage claim not resulting from product abuse.

### BRIEF SUMMARY

According to an aspect of the present invention, there is provided a method for auditing product damage claims by a warranty service department on consumer products subject to manufacturer warranty guidelines. The method comprises the steps of receiving a product damage claim on a consumer product from a consumer, detecting/downloading product impact sensor data from a product impact sensor on the consumer product, and determining the coverage available for a product damage claim under manufacturer warranty guidelines based upon a comparison of the product impact sensor data to a warranty level impact. In further embodiments of the present invention, the method for auditing may further include a step of processing the product impact sensor data into coded product impact data, as well as a step of generating a product impact report from the coded product impact data. The product impact report comprises product impact level data and product impact occurrence data. The product impact level data corresponds to a first state indicating authorization for warranty service under manufacture warranty guidelines when the product impact level does not exceed a warranty level impact. The product impact level data may also correspond to a second state indicating a denial of authorization for warranty service under manufacturer warranty guidelines when the product impact level data exceeds a warranty level impact. The product impact level data in the second state may create an irrebuttable presumption that authorization for warranty services should be denied. In this embodiment, both the consumer and the warranty service department would be precluded from challenging the product impact level data. Alternatively, product impact level data in the second state may create a rebuttable presumption that authorization for warranty service should be denied, thereby allowing either a consumer or manufacturer to present evidence that the product impact level data is in error, due to perhaps a malfunction in the product impact sensor.

This method for auditing is innovative in that it utilizes impact sensors embedded in consumer products to determine whether a product's disablement is caused by the shock, vibration, and blunt force resulting from droppage or mishandling of the consumer product. Accordingly, the auditing method described would reduce the amount of product damage claims authorizing product replacement and/or repair under a manufacturer's warranty guidelines when the evidence provided by the impact sensors indicates that the damage to a consumer product submitted under a product's warranty has been caused by product mishandling, misuse, and/or abuse. Such an auditing method could be cost-effectively administered by a manufacturer's warranty service department, thereby drastically reducing payments made for product damage claims not authorized under the terms of the manufacturer's product warranty guidelines.

According to various embodiments of the present invention, the method for auditing may utilize a piezoelectric sensor, strain gauge sensor, or other commercially available sensor as the product impact sensor.

In further embodiments of the present invention, the product impact sensor data collected by the product impact sensor may be readily viewable from the exterior of the consumer product. The product impact sensor may emit a first color indicator if the product impact level data corresponds to a first state. The product impact sensor may emit a second color indicator if the product impact level data corresponds to a second state. The product impact sensor may also be a meter, with the product impact sensor indicating authorization for warranty service when the meter reading is in a first range and a denial of service when the meter reading is in a second range.

In further embodiments of the present invention, the method for auditing may include a further step of calibrating the product impact sensor specifically for a portable consumer product, a home electronics consumer product, or a category-specific consumer product. Authorization for warranty service may be indicated for these types of consumer products when the product impact level data does not exceed a portable warranty level impact, a home electronics warranty level impact, and a category-specific warranty level impact, respectively.

This method for auditing is innovative in that it enables the manufacturer's warranty service department to set the product impact sensor such that a determination of warranty coverage may be made based upon the type of consumer application involved. For example, measurements taken from the product impact sensor for a portable consumer product, such as an MP3 player or an Apple IPOD, may be compared with a warranty level impact uniquely customized to smaller products, rather than using a generic warranty level impact for all types of consumer products. Clearly, a consumer would prefer that a coverage determination for a damage claim on a home electronics consumer product, such as a stereo or television, not utilize for comparative purposes the same warranty level impact as would apply to a portable consumer product. Due to the difference in size and weight between a home electronics consumer product and a portable consumer product, the shock or impact which may trigger a warranty level impact suggesting abuse or mishandling in the latter may not be sufficiently strong enough to trigger a warranty level impact in the former, thereby avoiding a “false positive” reading which would otherwise result in a denial of coverage. Likewise, a manufacturer would prefer to not be restricted in its coverage determination of a smaller product to a warranty level impact intended for larger products, leading to a “false negative” reading and improper authorization for warranty service. This will result in a more accurate and equitable determination of coverage for the specific type of product involved, thereby engendering confidence and credibility in the processing of product damage claims.

Other embodiments of the present invention may include a further step of graduating the impact level that qualifies for warranty service, in accordance with a corresponding graduated pricing level. The product impact sensor is calibrated to allow authorization for warranty service even when the product impact sensor data exceeds the prescribed warranty level impact. Authorization for warranty service may be indicated when the product impact sensor is calibrated such that a consumer is charged a first allowance pricing level up to a first warranty level impact. Similarly, the product impact sensor is calibrated such that a consumer may be charged a second allowance pricing level up to a second warranty level impact and a third allowance pricing level up to a third warranty level impact in order to receive supplemental warranty service on their consumer product. The method for auditing may include a first allowance pricing level that is less than a second allowance pricing level. This gives consumers the choice to purchase additional warranty coverage corresponding to the desired level of impact coverage for their consumer products. This option would be particularly beneficial if the consumer anticipates that the product will be subject to elevated levels of shock, vibration, or other adverse impacts which may otherwise trigger a denial of warranty service. Somewhat analagous to purchasing additional levels of insurance coverage, a consumer will be able to protect their products with the desired level of warranty service coverage, thereby prolonging the use and enjoyment of these products free from product malfunction. Likewise, the manufacturer warranty service will enjoy greater revenues from the sale of such supplemental coverage to the consumer.

According to another embodiment of the present invention, the method for auditing may include a further step of collecting product impact sensor data by a plurality of product impact sensors. The product impact sensor data collected by each of the plurality of product impact sensors may be viewable from the exterior of the consumer product. Each of the product impact sensors may emit a first color indicator if the product impact level data corresponds to a first state. Each of the product impact sensors may alternatively emit a second color indicator if the product level impact data correspond to a second state.

In yet another embodiment, a product impact report may be generated from the product impact sensor data using a product impact detection software program for use on a personal computer. The coded product impact data may be received by a warranty service department in electronic form. In another embodiment, the coded product impact data may be processed by a warranty service department using a computer network. In a further embodiment, the coded product impact data may be processed by an impact data reader, which may be portable.

According to another embodiment of the present invention, the product impact sensor data may be collected from the product impact sensor on an integrated circuit chip. This impact sensor data may then be processed using a product impact detection software program on a computer network.

According to another embodiment of the present invention, the method for auditing may further include a step of charging the customer for evaluating the product impact level data. The customer may be charged at a first pricing level for product impact level data shown to be in the first state and a second pricing level for product impact level data in the second state. The method for auditing may call for a first pricing level that is less than the second pricing level. The first pricing level may be at no charge to the consumer.

This method for auditing is innovative in that if the cost of processing a product warranty claim is passed on to the consumer, it may serve as a deterrent in discouraging consumers from submitting product damage claims they know to be caused by product mishandling, misuse, and/or abuse. Analogous to a “loser pays” system, a manufacturer warranty service department will have to process fewer product damage claims and will authorize for replacement and/or repair fewer disabled consumer products. This in turn will allow more resources to be devoted to the expedited processing of legitimate product damage claims.

In yet a further embodiment of the present invention, the product impact report data may be stored in a computer's temporary data storage location, commonly referred to as Random Access Memory (RAM).

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a flow chart of a method for auditing product damage claims according to an aspect of the present invention;

FIG. 2 is a schematic diagram illustrating the interaction between a consumer and a manufacturer warranty service department in the submission and processing of a product damage claim according to an aspect of the present invention;

FIG. 3 is an exploded view of a first embodiment of a method for auditing utilizing a product impact sensor viewable from the exterior of a consumer product, with FIG. 3a depicting a product impact sensor emitting a first color indicator, FIG. 3b depicting a product impact sensor emitting a second color indicator, and FIG. 3c depicting a product impact sensor which is a meter;

FIG. 3d is an exploded view of a method for auditing utilizing a plurality of product impact sensors on a consumer product;

FIG. 3e depicts the product impact sensor embedded within the consumer product, and FIG. 3f depicts the product impact sensor partially embedded within the consumer product.

FIG. 4 is a schematic diagram illustrating the method for auditing a product damage claim for a portable consumer product, home electronics consumer product, and a category-specific consumer product, including the generation of a product impact report for each type of consumer product.

### DETAILED DESCRIPTION

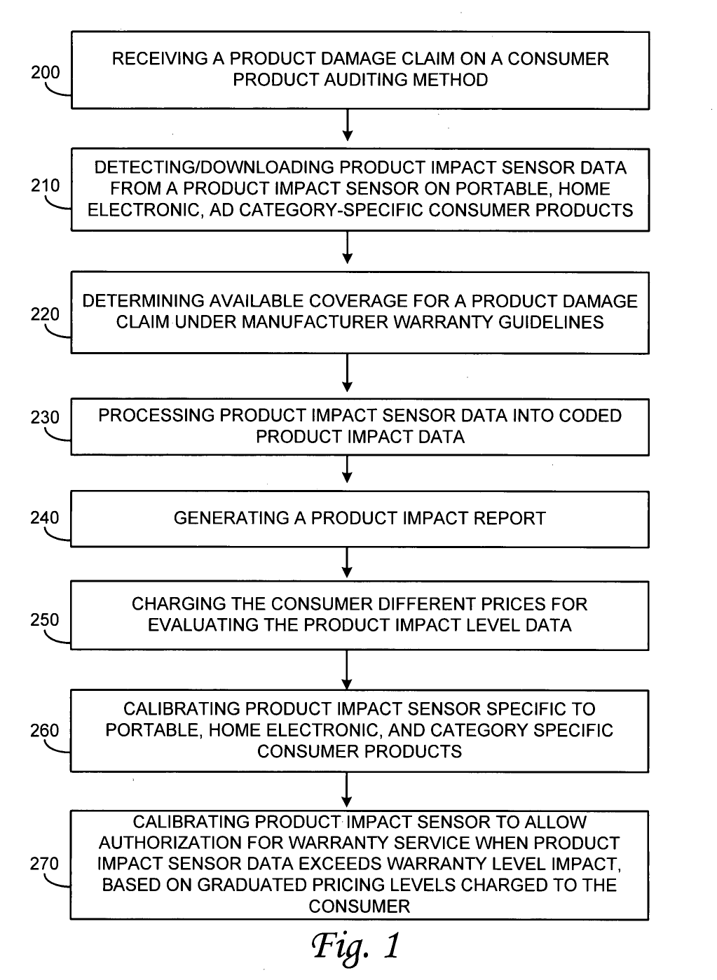

The drawings referred to herein are for the purposes of illustrating the preferred embodiments of the present invention and not for the purposes of limiting the same. FIG. 1 is a flow diagram indicating the steps of a method for auditing product damage claims 30 by a warranty service department 86 on consumer products 32 subject to manufacturer warranty guidelines 24. In this regard, this methodology is from the perspective of the warranty service department 86. According to an aspect of the present invention, the method comprises step 200 of the warranty service department 86 receiving a product damage claim 30 on a consumer product 32 from a consumer 78, step 210 of the warranty service department detecting/downloading product impact sensor data 12 from a product impact sensor 10 on the consumer product 32, and step 220 of the warranty service department 86 determining the availability of coverage for a product damage claim 30 under manufacturer warranty guidelines 24 based upon a comparison of the product impact sensor data 12 to a warranty level impact 26. In another embodiment of the auditing method, step 230 of the warranty service department 86 includes processing the product impact sensor data 12 into coded product impact data 14, and step 240 the warranty service department 86 includes generating a product impact report 16 from the coded product impact data 14. These embodiments take into account that the warranty level impact 26 may differ based upon the type of the consumer product 32 for which a product damage claim 30 is being submitted. The product impact report 16 includes product impact level data 18 and product impact occurrence data 20. The product impact level data 18 is based upon the magnitude of shock, vibration, and/or blunt force to which a consumer product 32 has been subject to as a result of possible droppage, compression, or other mishandling by the consumer 78, as detected by the product impact sensor 10. The product impact level data 18 may correspond to a first state 22 indicating authorization for warranty service by the warranty service department 86 under the manufacturer warranty guidelines 24 when the product impact level data 18 does not exceed a warranty level impact 26 prescribed by the manufacturer warranty service department 86. Similarly, the product impact level data 18 will correspond to a second state 28 indicating a denial of authorization for warranty service by the warranty service department 86 under manufacturer warranty guidelines 24 when the product impact level data 18 exceeds the warranty level impact 26 prescribed by the warranty service department 86. The product impact occurrence data 20 identifies by date and time as to when the consumer product 32 experienced a shock, vibration, and/or blunt force which resulted in the detection of product impact sensor data 12 by the product impact sensor 10.

This auditing process uniquely enables the auditing of product damage claims 30 received from a consumer 78 by the manufacturer's warranty service department 86. A warranty service department 86 is now able to evaluate the timing and magnitude of impact sustained by a consumer product 32 with precision such that a product damage claim 30 can be evaluated with all of the facts at the disposal of the warranty service department 86 necessary for making an accurate determination of coverage under a manufacturer's warranty guidelines 24. This in turn enables a warranty service department 86 to authorize for replacement and/or repair of product damage claims 30 which are appropriate under the manufacturer warranty guidelines 24 as reflected by the product impact level data 18 and product impact occurrence data 20 evidence. Due to the reliability of this evidence, the determination of coverage for a product damage claim 30 may be virtually incontestable. In the embodiment, the existence of product impact level data 18 in the second state 28 creates an irrebuttable presumption that authorization for warranty service should be denied. In another embodiment the auditing method calls for rebuttable presumption that the product impact level data 18 is correct, allowing the consumer 78 to challenge the results. As a result, the manufacturer's warranty service department 86 will be able to make accurate determinations of coverage in a cost-effective manner based on the product impact level data 18 and product impact occurrence data 20, thereby drastically reducing the processing costs and payments made on product damage claims 30 resulting from consumer mishandling, misuse, and/or abuse of consumer products 32.

In another embodiment, the method for auditing may include a further step 250, wherein the consumer 78 is charged by the warranty service department 86 for the evaluation of the product impact level data 18 presented with the product damage claim 30. In a further embodiment, the consumer 78 may be charged for the processing of their product damage claim 30 at a first pricing level if the product impact level data 18 is shown to be in the first state 22. The consumer 78 may be charged at a second pricing level if the product impact level data 18 is shown to be in the second state 28. The first pricing level may be less than the second pricing level. In yet a further embodiment the first pricing level charged the consumer 78 may be at no charge if the product impact level data 18 is shown to be in the first state.

As described in step 260 of FIG. 1, other embodiments of the present invention may include a further step of calibrating the product impact sensor 10 such that the warranty level impact 26 is customized to a specific consumer product 32 application. For example, the auditing method may include a further step of calibrating the product impact sensor 10 for a portable consumer product 44 with authorization for warranty service indicted when the product impact sensor data 12 does not exceed a portable warranty level impact 48. Portable consumer products 44 may include an MP3 player or APPLE IPOD as examples. Similarly, another embodiment may include a step of calibrating the product impact sensor 10 for a home electronics consumer product 52, with authorization for warranty service indicated when the product impact sensor data 12 does not exceed a home electronics warranty level impact 56. Examples of home electronics consumer products 52 include televisions, stereos systems, and fax machines. In yet a further embodiment, the auditing method may further include a step 270 of calibrating the product impact sensor 10 for a home electronics consumer product 52, with authorization for warranty service indicated when the product impact sensor data 12 does not exceed a category-specific warranty level impact 64. Examples of category-specific consumer products include washing machines and similar appliances. The differences in size and weight between a home electronics consumer product 52 and a portable consumer product 54, particularly taking into account the significant difference between the shock or impact needed to trigger a warranty level impact 26 in a portable consumer product 44 as compared with a home electronics consumer product 52, the customization of warranty level impacts 26 specific to consumer product 32 applications produces a more accurate and equitable determination of coverage based on the type of consumer product 32 which is the subject of the product damage claim 30.

Implementation of these embodiments of the method for auditing may serve as a deterrent for the consumer 78 to submit a product damage claim 30 which they suspect will reveal that the product level impact data 18 exceeds the warranty level impact 26 due to product mishandling or abuse.

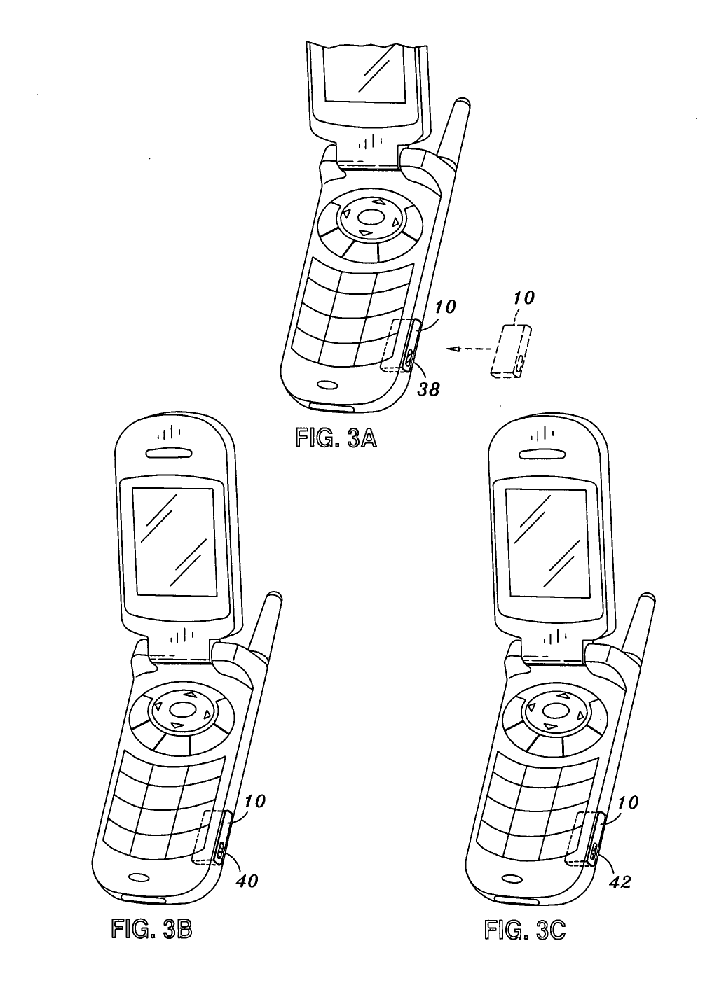

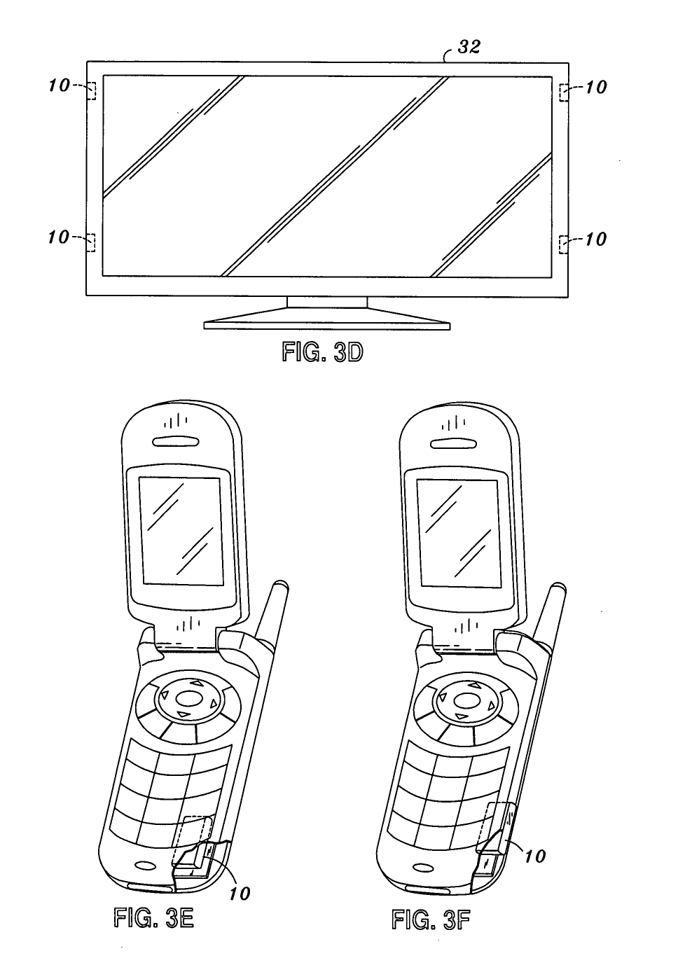

Referring now to FIG. 3, another embodiment of the auditing method may include the collection of product impact sensor data 12 from a product impact sensor 10 which is located on and viewable from the exterior of the consumer product 32. As is depicted in FIG. 3a, the product impact sensor 10 may be found on the outside of the consumer product 32 (for example, a cell phone), and may emit a first color indicator 38 (such as white) when the product impact level data 18 corresponds to a first state 22 authorizing warranty service under manufacturer warranty guidelines 24. In this embodiment of the auditing method, both the consumer 78 and the warranty service department 86 will be able to determine whether the consumer product 32 qualifies for warranty service by merely looking at the first color indicator 38 located on the outside of the consumer product 32. This may result in the reduction of product damage claims 30 believed by the consumer 78 to not qualify for warranty service, and the encouragement of submitting product damage claims 30 believed to qualify for warranty service. Alternatively, as is depicted in FIG. 3b, the product impact sensor 10 may emit a second color indicator 40 when the product impact level data 18 corresponds to a second state 28 requiring denial of authorization for warranty service on a product damage claim 30. Referring now to FIG. 3c, the product impact sensor 10 viewable from the exterior of the consumer product 32 may be a meter 42. In this embodiment of the auditing method, a determination may be made concerning warranty service by observing whether the meter 42 indicates the existence of product impact sensor data 12 in the first state 22 or the second state 28. In yet another embodiment depicted in FIG. 3e, the product impact sensor data 12 may be collected from a product impact sensor 10 embedded completely inside the consumer product 32. As depicted in FIG. 3f, the product impact sensor 10 may also be only partially embedded inside the consumer product 32.

Still referring to FIG. 3, an embodiment of the auditing method may include a step of collecting product impact sensor data 12 from a plurality of product impact sensors 10. FIG. 3d depicts the placement of a plurality of product impact sensors 10 on a consumer product 32 (for example, a television set). In this embodiment, each of the product impact sensors 10 may be responsible for the detection of different types of shock, vibration, and/or force experienced in different regions of the consumer product 32. Accordingly, thorough and accurate determination may be made on a product damage claim 30 that may concern only a part of or the entire consumer product 32. In another embodiment, each of the plurality of product impact sensors 10 may be viewable from the exterior of the consumer product 32. These product impact sensors 10 may each emit a first color indicator 38 if warranty service is authorized and a second color indicator 40 if warranty service is not authorized for the product damage claim 30.

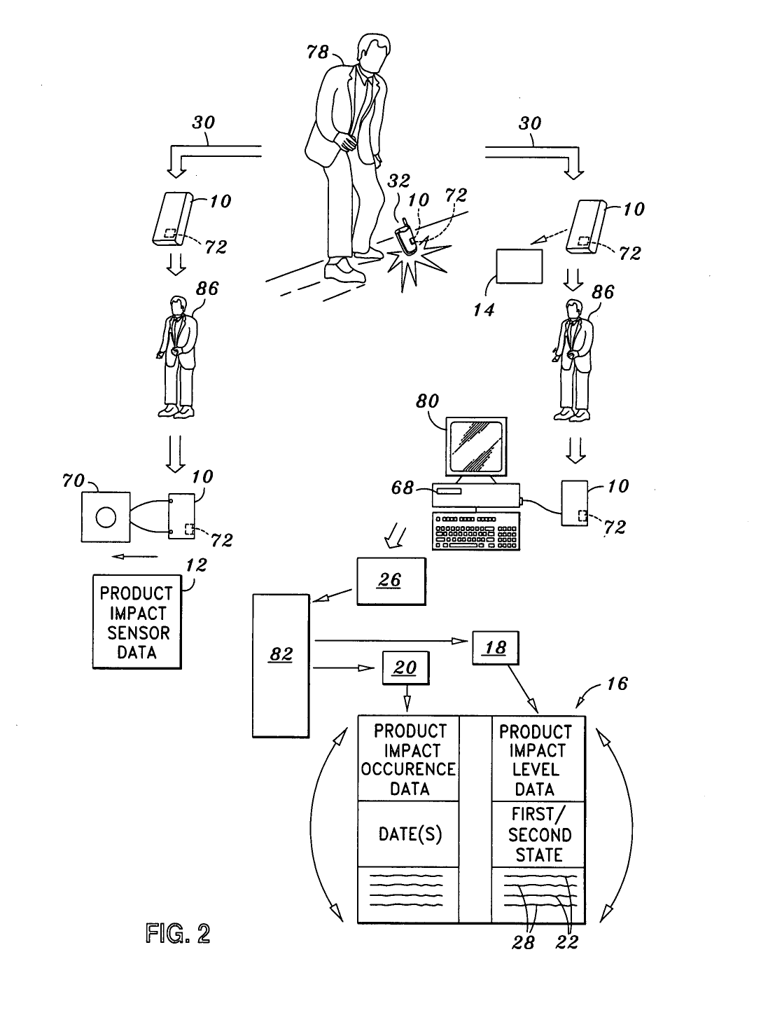

Referring now to FIG. 2, there is depicted a diagram of another embodiment of the present invention, wherein the customer 78 presents a product damage claim 30 for evaluation and auditing by the manufacturer's warranty service department 86. In one embodiment, the consumer 78 may present the consumer product 32 having a product impact sensor 10 wherein the coded product impact data 14 detected from the product impact sensor 10 may be processed using an impact data reader 70. The impact data reader 70 may be portable. In another embodiment, the product impact sensor 10 on the consumer product 32 may also include an integrated circuit chip 72 on which the product impact sensor data 12 is collected. In another embodiment, the coded product impact data 14 collected on an integrated circuit chip 72 may then be processed using a product impact detection software program 68, such as that which may be found on a personal computer or computer network 80. Alternatively, the product damage claim 30 may be received by the manufacturer's warranty service department 86 in electronic form, such as on a CD or via email. In another embodiment, the product impact report may be stored in the Random Access Memory (RAM) of a personal computer 80. The product impact detection software program 68 may then process the coded product impact data 14 into product impact level data 18 for comparison with the manufacturer's warranty level 26. The product impact level data 18 and product impact occurrence data 20 processed through the product impact detection software program 68 can then be generated in a product impact report 16. The product impact level data 18 reflected in the product impact report 16 will indicate whether the product impact level data exceeds the warranty level impact 26 and whether warranty service is authorized or denied.

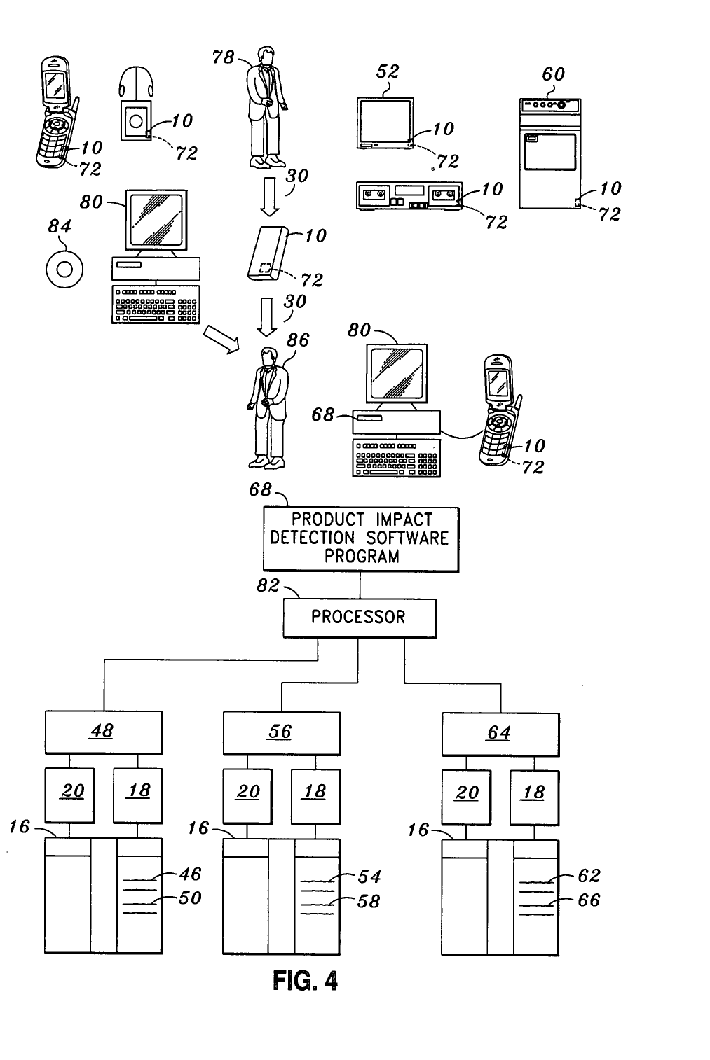

Referring now to FIG. 4, in another embodiment of the present invention, the consumer product 32 may be a portable consumer product 44 such as a cellular telephone, CD or DVD player, or MP3 player. The warranty service department 86 may receive the coded product impact data 12 in electronic form 84 such as on a compact disk (CD).

In other embodiments of the auditing method and as described in step 270 of FIG. 1, the auditing method may further include a step of calibrating the product impact sensor 10 to allow authorization for warranty service when the product impact sensor data 12 exceeds the warranty level impact 26. The warranty service department 86 may charge a graduated payment structure, whereby a consumer 78 is charged an increasing amount to allow authorization for warranty service, depending upon the extent to which the product impact sensor data 12 exceeds the warranty level impact 26. For example, the auditing method may include a step of calibrating the product impact sensor 10 such that a consumer 78 is charged a first allowance pricing level 88 when the product impact sensor data 12 indicates the occurrence of a triggering event that exceeds a first warranty level impact 90. Likewise, the product impact sensor 10 may be calibrated such that the consumer 78 is charged a second allowance pricing level 92 for product impact sensor data 12 that exceeds a second warranty level impact 94. Further graduation of the payment structure for product damage claims 30 audited by the warranty service department 86 may further include a third allowance pricing level 96 when the product impact sensor data 12 exceeds a third warranty level impact 98. In an embodiment of the present invention, the second allowance pricing level 92 may exceed the first allowance pricing level 88, such that a consumer 78 will pay more to have the product impact sensor data 12 exceed the second warranty level impact 94 than the first warranty level impact 90, and yet still receive authorization for warranty service on its consumer product 32. As in the case of obtaining supplemental insurance coverage, a consumer 78 may be able to purchase additional warranty coverage for a product damage claim 30 when they anticipate that their consumer product 32 may be exposed to a higher risk of shock, vibration, or other adverse impacts which would otherwise trigger a denial of warranty service. The consumer 78 in turn will likely enjoy the use of their consumer product 32 for a longer period with extended coverage for repairs and/or replacement.

In one embodiment, the product impact detection software program found on a personal computer or computer network 80 may process the product impact level data 18 collected on an integrated circuit chip 72 coupled to the product impact sensor 10. The product impact detection software program 68 may generate a product impact report 16 for the portable consumer product 44, indicating whether the product impact level data 18 for the portable consumer product 44 corresponds to a first state 22 that does not exceed the warranty level impact 26, thereby authorizing warranty service, or whether the product impact level data 18 for the portable consumer product 44 exceeds the warranty level impact 26 and is therefore in the second state 28, thereby denying authorization for warranty service under the manufacturer's warranty guidelines 24. In another embodiment, the consumer product 32 may be a home electronics consumer product 52, such as a flat panel television or audio receiver. In this embodiment, the product impact detection software program 68 will generate a product impact report 16 indicating whether product impact level data 18 for the home electronics consumer product 52 does not exceed the warranty level impact 26 and therefore corresponds to first state 22, or whether the product impact level data 18 exceeds the warranty level impact 26, in which case it corresponds to a second state 28 with authorization for warranty service denied. In yet a further embodiment, the product impact sensor 10 may be found on a category-specific consumer product 60, such as a washer or dryer. In the event the product impact level data 18 for the consumer product 60 does not exceed the warranty level impact 26, it shall correspond to a first state 22, thereby authorizing warranty service. If the product impact level data 18 for the category-specific consumer product 60 exceeds the category-specific warranty level impact 64, it shall correspond to a second state 28, with authorization for warranty service denied under the manufacturer's warranty guidelines 24.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A method for auditing product damage claims by a warranty service department on consumer products subject to manufacturer warranty guidelines, the method comprising the steps of:
a) receiving a product damage claim on a consumer product from a consumer;
b) detecting/downloading product impact sensor data from a product impact sensor on the consumer product;
c) determining the coverage available for a product damage claim under manufacturer warranty guidelines based upon a comparison of the product impact sensor data to a warranty level impact.

2. The method for auditing as claimed in claim 1 further including a step of processing the product impact sensor data into coded product impact data.

3. The method for auditing as claimed in claim 2 further including a step of generating a product impact report from the coded product impact data, the product impact report including product impact level data and product impact occurrence data, the product impact level data corresponding to a first state indicating authorization for warranty service under manufacturer warranty guidelines when the product level impact data does not exceed the warranty level impact, and a second state indicating a denial of authorization for warranty service under manufacturer warranty guidelines when the product impact level data exceeds the warranty level impact.

4. The method for auditing as claimed in claim 3, wherein product impact level data in the second state creates an irrebuttable presumption that authorization for warranty service should be denied.

5. The method for auditing as claimed in claim 3, wherein product impact level data in the second state creates a rebuttable presumption that authorization for warranty service should be denied.

6. The method for auditing as claimed in claim 1, wherein the product impact sensor is a piezoelectric sensor.

7. The method for auditing as claimed in claim 1, wherein the product impact sensor is a strain gauge sensor.

8. The method for auditing as claimed in claim 1, wherein the product impact sensor is embedded inside the consumer product.

9. The method for auditing as claimed in claim 1, wherein the product impact sensor is partially embedded inside the consumer product.

10. The method for auditing as claimed in claim 1, wherein the product impact sensor data collected by the product impact sensor is viewable from the exterior of the consumer product.

11. The method for auditing as claimed in claim 10, wherein the product impact sensor is characterized by a first color indicator corresponding to a first state and by a second color indicator corresponding to a second state.

12. The method for auditing as claimed in claim 10, wherein the product impact sensor is a meter.

13. The method for auditing as claimed in claim 12, wherein the product impact sensor data from the meter corresponds to a first range indicating authorization for warranty service under manufacturer warranty guidelines, and a second range indicating denial of authorization for warranty service under manufacturer warranty guidelines.

14. The method for auditing as claimed in claim 1 further including a step of calibrating the product impact sensor for a portable consumer product, wherein authorization for warranty service is indicated when the product impact sensor data does not exceed a portable warranty level impact.

15. The method for auditing as claimed in claim 1 further including a step of calibrating the product impact sensor for a home electronics consumer product, wherein authorization for warranty service is indicated when the product impact sensor data does not exceed a home electronics warranty level impact.

16. The method for auditing as claimed in claim 1 further including a step of calibrating the product impact sensor for a category-specific consumer product, wherein authorization for warranty service is indicated when the product impact sensor data does not exceed a category-specific warranty level impact.

17. The method for auditing as claimed in claim 1 further including a step of callibrating the product impact sensor to allow authorization for warranty service when the product impact sensor data exceeds the warranty level impact.

18. The method for auditing as claimed in claim 17, further including a step of calibrating the product impact sensor such that a consumer is charged a first allowance pricing level up to a first warranty level impact.

19. The method for auditing as claimed in claim 18, further including a step of calibrating the product impact sensor such that a consumer is charged a second allowance pricing level up to a second warranty level impact.

20. The method for auditing as claimed in claim 18, wherein the second allowance pricing level is greater than the first allowance pricing level.

21. The method for auditing as claimed in claim 19, further including a step of calibrating the product impact sensor such that a consumer is charged a third allowance pricing level up to a third warranty level impact.

22. The method for auditing as claimed in claim 1 further including a step of collecting product impact sensor data by a plurality of product impact sensors.

23. The method for auditing as claimed in claim 22, wherein the product impact sensor data collected by each of the product impact sensors is viewable from the exterior of the consumer product.

24. The method for auditing as claimed in claim 22, wherein each of the product impact sensors emit a first color indicator corresponding to a first state and a second color indicator corresponding to a second state.

25. The method for auditing as claimed in claim 3, wherein the product impact report is generated using a product impact detection software program.

26. The method for auditing as claimed in claim 3, wherein the coded product impact data is received in electronic form.

27. The method for auditing as claimed in claim 3, wherein the coded product impact data is processed via a computer network.

28. The method for auditing as claimed in claim 3, wherein the coded product impact data is processed via an impact data reader.

29. The method for auditing as claimed in claim 28, wherein the impact data reader is portable.

30. The method for auditing as claimed in claim 1, wherein the product impact sensor data is collected on an integrated circuit chip.

31. The method for auditing as claimed in claim 1 further includes a step of charging the consumer for evaluating the product impact level data.

32. The method for auditing as claimed in claim 31, wherein the customer is charged at a first pricing level for product impact sensor data that does not exceed the warranty level impact, and a second pricing level for product impact sensor data that exceeds the warranty level impact.

33. The method for auditing as claimed in claim 32, wherein the first pricing level is less than the second pricing level.

34. The method for auditing as claimed in claim 32, wherein the first pricing level is at no charge.

35. The method for auditing as claimed in claim 1, wherein the product impact report data is in Random Access Memory (RAM).
